(19) United States
(12) Patent Application Publication
(10) Pub. No.: US 2026/0011078 A1
(43) Pub. Date: Jan. 8, 2026

(54) SYSTEMS AND METHODS FOR A DIGITAL WORLD

(71) Applicant: Huawei Technologies Co., Ltd., Shenzhen (CN)

(72) Inventor: Hang Zhang, Ottawa (CA)

(21) Appl. No.: 19/327,885

(22) Filed: Sep. 12, 2025

Related U.S. Application Data
(63) Continuation of application No. PCT/CN2023/082234, filed on Mar. 17, 2023.

(51) Int. Cl. G06T 17/00

(52) U.S. Cl. CPC G06T 17/00

(57) ABSTRACT

A communication system is provided. The communication system may include a system control manager (system C/M), a digital user platform configured to support at least one digital user profile, a digital infrastructure platform configured to support at least one digital infrastructure platform instance, and/or a virtual reality service platform configured to support at least one virtual reality service slice. In some cases, the system C/M may be configured to establish and coordinate interaction between the digital user platform, the digital infrastructure platform and the virtual reality service platform.

### CROSS-REFERENCE TO RELATED APPLICATIONS

This application is a continuation of International Application No. PCT/CN2023/082234, filed on Mar. 17, 2023, the disclosure of which is hereby incorporated by reference in its entirety.

### TECHNICAL FIELD

This invention pertains generally to the field of computerized communication systems and in particular to communication infrastructures for implementing a digital world.

### BACKGROUND

Virtual worlds are environments that simulate a real-world environment or system. One type of a virtual world is a computer-simulated representation of a physical world that includes virtual spatial and/or physical characteristics. In some virtual worlds, users who participate in the virtual world may adopt a virtual representation of themselves, commonly known as an “avatar”.

An example of a virtual world technology is virtual reality. In a virtual reality a user is able to wear ocular or tactile interfaces that are operative to provide physical feedback to the user in the physical world. Well-known examples of virtual realities include video games and conference or meeting worlds. Other examples of virtual world technology that may overlap with virtual reality include: simulators such as flight or driving simulators, operating room simulators, education or learning simulators for complex tasks. In recent years a lot of development has been directed to improving the fidelity of the feedback to make the virtual world as immersive as possible to the user.

In some virtual realities the user is able to move about the physical environment and the information received from the virtual world changes based as the perspective of the user changes from motion in the physical world. The physical feedback provided by the interfaces is typically tied to the spatial and/or physical characteristics of the virtual world. In some cases, the virtual spatial and/or physical characteristics may be adapted to mimic or follow a user's understanding of the physical world. In some cases, the which may be virtual spatial and/or physical characteristics may be adapted to immerse the user in an alien world, such as being placed in zero gravity or simulating a high g-force environment such as a racing car or airplane.

While virtual realities are a well-known type of virtual world, there are other applications of virtual worlds that don't aim to place a user in a virtual representation of the physical world, such as infrastructure simulations or network simulations.

Currently virtual world technology is offered as single-use platforms or applications, such as for a video game or network simulation. The architecture of the virtual world being custom built for that application and the tools available limited. Accessing the virtual world technology is commonly through a local computing system, such as a PC, video game console, or custom simulator system (e.g. for flight simulators). While there are examples of remote or distributed virtual worlds, these applications are structured around current communication systems which provide connectivity services only and are generally managed and operated by a single party, referred to as a network operator.

The term virtual world may be used to describe an interface that mimics another world or environment. In some usage, the term virtual world implies that the other world or environment is the “real”, i.e. physical world, whereas a term such as “digital world” implies an interface that mimics some other world or environment. In a broader context, the term digital world is often used to include simulated or modelled environments that may simulate any of a real-world environment, a theoretical, or an artificial environment. In this context the modelled environment may or may not exist in the “real-world”.

In the context of the present application, the terms “digital world” and “virtual world” are used synonymously to denote a simulated environment and/or interface that mimics or represents another environment or world that may include a real-world environment, a simulated environment, a theoretical environment, and/or an artificial environment.

It is anticipated that future communication networks, (e.g. 6^{th} Generation (6G) systems as defined by the 3GPP) will go beyond connectivity provisioning to offer various new services. It is also anticipated the future communication systems may be operated by multiple parties, for example with different parties operating a different portion of the communication system to offer certain services. These services may be provided for the system's (e.g. operating party's) internal use or for an end customer's use.

However, current communication systems and infrastructure require further development to support the above scenario and comparable scenarios. Such development is not straightforward and can require solving of a variety of technical and design problems.

To address this issue, it is expected that the computing and processing works of heterogeneous services can be decoupled from centralized cloud server nodes, and be deeply deployed into the network or edge (e.g. on radio node). In example of a service-oriented communication system is the next-generation mobile communications system, 6G, which is expected to go far beyond providing communication pipelines or connectivity to intelligence. 6G will employ a X-centric architecture to enable computing and processing capabilities of different services in a distributed and collaborated manner. The X-centric architecture is defined to support anything as a service (XaaS) services (or service in short) with heterogeneous processing and computing requirements. For instance, NET4AI (also referred to as Network AI) is a typical XaaS service that aims to intelligently connect distributed intelligent nodes/agents in the network to proliferate large-scale deployment of AI in all industries. In another instance, data analytics and management (DAM) is another XaaS service that aims to monitor and analyze data sources for the AI applications. To support XaaS services, the core network (CN)/radio access network (RAN) in 6G will be enabled with computing capabilities (i.e., modules/nodes to provide computing resources and management of computing procedures) and be redesigned with new control/management (C/M) plane functions to schedule/coordinate the network-based computing and processing capabilities.

Moreover, in some cases both the computing and processing capabilities, and part of the corresponding control functions for an XaaS service can be provided by third-party providers (e.g., an independent AI solution provider may design their own module containing the corresponding processing and control functions for a XaaS service and plug it in the 6G CN/RAN network). To support the third-party provided XaaS service modules, the future 6G networks should have a global control functionality across multiple XaaS services and define the general procedures of processing and control the XaaS services.

There is a need for a method, apparatus and system for implementing digital worlds as an XaaS service delivery, that obviates or mitigates one or more limitations in the prior art.

This background information is intended to provide information that may be of possible relevance to the present disclosure. No admission is necessarily intended, nor should be construed, that any of the preceding information constitutes prior art against the present disclosure.

### SUMMARY

In embodiments of the present disclosure, systems and methods are provided for a communication network that supports one or more digital worlds.

In some embodiments, a communication system is provided. The communication system may include: a system control manager (C/M); a digital user platform operative to support at least one digital user profile; a digital infrastructure platform operative to support at least one digital infrastructure platform instance; and, a virtual reality service platform operative to support at least one virtual reality service slice. The system C/M may be operative to establish and coordinate interaction between the digital user platform, the digital infrastructure platform and the virtual reality service platform.

In some aspects, the C/M is further operative to interface a service entity outside of the communication system, and to facilitate information exchange between the service entity and the digital user platform, the digital infrastructure platform and the virtual reality service platform.

In some aspects, the service entity comprises an “anything as a service” (XaaS) entity outside of the communication system.

The communication system may further include a digital user C/M operative to manage access to information stored, processed, and/or generated by the digital user platform.

In some aspects, the digital user platform is further operative to: receive a platform C/M configuration request from the system C/M, configure the digital user C/M in accordance with the platform C/M request, and to transmit to the system C/M a corresponding platform C/M configuration response confirming the configuration.

The communication system may further include a digital infrastructure platform C/M operative to provide control and management functions for digital infrastructure platform instances provided by the digital infrastructure platform.

In some aspects, the digital infrastructure platform is further operative to: receive a platform C/M configuration request from the system C/M, configure the digital infrastructure platform C/M in accordance with the platform C/M request, and to transmit to the system C/M a corresponding platform C/M configuration response confirming the configuration.

The communication system may further include a virtual reality service platform C/M operative to provide lifecycle management for one or more virtual reality service slices.

In some aspects, the virtual reality service platform is further operative to: receive a platform C/M configuration request from the system C/M, configure the virtual reality service platform C/M in accordance with the platform C/M request, and to transmit to the system C/M a corresponding platform C/M configuration response confirming the configuration.

In some aspects, at least one of the digital user profiles further comprises a virtual anchor point operative to receive incoming calls or messages.

In some embodiments, a digital user platform is provided. The digital user platform may include a digital user C/M and one or more digital user profiles. The digital user C/M may be operative to manage access to information stored, processes, and/or generated by each of the one or more digital user profiles.

In some embodiments, a digital infrastructure platform is provided. The digital infrastructure platform may include: one or more digital infrastructure platform instances; a simulation/test environment platform, operative to carry out simulation or evaluation of the one or more digital infrastructure platform instances; and, a simulation/test tool library, including at least one simulation tool callable by the simulation/test environment platform.

In some embodiments, a virtual reality service platform is provided. The virtual reality service may include a virtual reality service platform C/M and one or more virtual reality service slices. The virtual reality service platform C/M may be operative to manage each virtual reality service slice.

### BRIEF DESCRIPTION OF THE DRAWINGS

FIG. 1 is an illustrative embodiment of a simplified architecture schematic of a communication system.

FIG. 2 is an illustrative embodiment of a simplified architecture schematic of a virtual user platform.

FIG. 3 is an illustrative embodiment of a simplified architecture schematic of a virtual infrastructure platform.

FIG. 4 is an illustrative embodiment of a simplified architecture schematic of a virtual service platform.

FIG. 5 illustrates a computing device that may perform computing or related operations according to embodiments of the present disclosure.

It will be noted that throughout the appended drawings, like features are identified by like reference numerals.

### DETAILED DESCRIPTION OF THE ILLUSTRATIVE EMBODIMENT

As used herein, the term “anything-as-a-service,” i.e. “XaaS” can reflect the concept as it has been proposed in the computer networking industry. For example, XaaS can be conceptualized as a generalization of software-as-a-service or infrastructure-as-a-service concepts. XaaS can leverage cloud computing and device virtualization concepts, coupled with a service model to deliver a variety of functionalities. According to embodiments of the present disclosure, XaaS can describe for example that the functionality of an arbitrary module disclosed herein can be provided as a service to another module or an external entity, such as a customer. The phrase “as service” is used herein to be synonymous with “as a service.”

An open system architecture may refer to a design approach in which systems (e.g. modules) are interoperable and interconnectable with one another, generally without requiring retrofit or redesign. An open system architecture is one approach for achieving a modular design in which modules are configured to be interoperable.

The term “X-centric” refers to the capability of embodiments to be reconfigurable so that they are either infrastructure-provider centric, third-party centric, customer centric, or the like, or a combination thereof. Other types of configurations may also be supported. Multiple possible mappings between parties and roles are thus supported, with different X-centric scenarios corresponding to different mappings. This facilitates an architectural openness with support for multiple operation scenarios.

According to embodiments of the present disclosure, there is provided a networked computing and communication system comprising multiple different types of modules in an open system architecture. On one layer, infrastructure modules each provide a respective infrastructure resource as service. Infrastructure resources may include real computing, communication or data storage resources. On another layer, service modules each provide a respective functionality as service. Service module functionalities may be functionalities that can be utilized by an end user or other module. The service modules may utilize at least one of the infrastructure resources as service. On another layer, management and control modules each provide a respective management or control resource as service. Management and control resources may be used to manage other modules, missions of modules, module operations, or other management or control tasks. At least one of the management and control modules may provide its respective management or control resource as service to at least one of the infrastructure modules or the service modules. Each module may provide its functionality as a service, on an as-needed basis, to one, some or all modules of the same layer or of different layers. Modules can be interconnected to provide services to one another in a configurable manner depending on operational requirements. Different modules can be provided or operated by different parties, in order to provide for different X-centric configurations, which may be party-centric configurations.

In the context of the present disclosure, a device may be any terminal user equipment of the network such as, for example, a cellphone, a personal computer or a laptop, an IoT device like sensor, smart home devices, a vehicle connected to the vehicular network, an AR/VR (augmented reality/virtual reality) device, a satellite, etc. Any electrical device can be recognized as a device by the network.

Embodiments of the present disclosure describe systems and methods for supporting and providing digital worlds over an X-centric communication system. In some embodiments, a digital world may include interaction with one or more other environments.

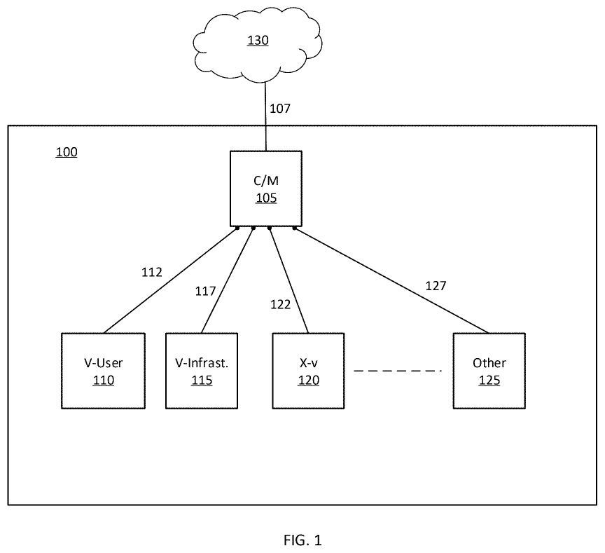

FIG. 1 is an illustrative embodiment of a simplified architecture schematic of an X-centric communication system 100 for implementing, supporting, and managing digital worlds. In the embodiment of FIG. 1, the communication system 100 includes a system control manager (C/M) 105 and a plurality of virtual platforms including at least one of a digital user platform 110, a digital infrastructure platform 115, and a digital service platform 120 (i.e. a “virtual reality service platform”). In some embodiments there may be additional virtual reality service platforms 120 and/or additional other service platforms 125 under control and management of the system C/M 105. The system C/M 105 includes network functions operative to establish the digital platforms, coordinate interaction among platforms, and to interface with other service entities, such as an XaaS entity, available on the network 130.

In some embodiments, the digital user platform 110 and/or the digital infrastructure platform 115 may be provided as standalone platforms outside of, and independent from, the X-centric communication system 100.

C/M interface 107 is an interface between the communication system 100 and other XaaS modules in communication with the system C/M 105 of the communication system 100. Digital user interface 112 is an interface between the system C/M 105 and the digital user platform 110. Digital infrastructure interface 117 is an interface between the system C/M 105 and the digital infrastructure platform 115. Digital service interface 122 is an interface between the system C/M 105 and the virtual reality service platform 120. Other service interface 127 corresponds to an interface between the system C/M 105 and an additional other service platform 125.

In some embodiments, five or more types of signaling messages may be supported on the digital communication system 100. These may include, for instance: platform establishment messages; platform C/M configuration messages; platform service messages; information sharing coordination messages; and, external signaling messages.

The platform establishment messages include platform creation requests, platform creation responses, and may stipulate platform resourcing (e.g. allocated storage capacity, computing capacity, connectivity capability, etc.).

The platform C/M configuration messages include platform C/M configuration requests and platform C/M configuration responses corresponding to each of the platforms (i.e. digital user platform 110, digital infrastructure platform 115, virtual reality service platform 120, other service platforms 125). The system C/M 105 is operative to transmit platform C/M configuration requests to each of the platforms, and the platforms are each operative to configure their respective C/M functions response to a received platform C/M configuration requests and to transmit to the system C/M 105 a corresponding platform C/M configuration response confirming the configuration implemented by the platform C/M.

The platform service messages include platform service requests and platform service responses, and may stipulate resourcing at the service level within a platform (e.g. allocated storage capacity, computing capacity, connectivity capability, etc.).

The information sharing coordination messages include information sharing request and information sharing responses between digital platforms and service entities, such as XaaS services, through the system C/M 105. For example, the virtual reality service platform C/M may transmit a digital service (i.e. virtual reality) slice request to the system C/M 105. The system C/M 105 may then determine the relevant information required to respond to the slice request, as well as other digital platforms (e.g. digital user platform 110 and digital infrastructure platform 115) that may have relevant data responsive to the received slice request (e.g. digital user IDs, digital infrastructure IDs, etc.). As another example, the digital user platform 110 and/or the digital infrastructure platform 115 may transmit information sharing requests to obtain relevant information from the system C/M 105. The request may include, for instance, a digital user ID and/or a digital platform ID. The system C/M 105 may in turn obtain the relevant information and transmit an information sharing response to the identified services corresponding to the received digital user ID and/or digital infrastructure ID.

The external signaling messages may include messages transmitted through the C/M interface 107 to external entities, such as external physical users, external data stores, etc. to exchange information. The external signaling messages may be generated by the virtual reality service platforms, or may be generated by the system C/M 105 responsive to a request for external information received from one of the virtual reality service platforms.

The digital user platform 110 enables physical users to better manage a variety of interactions with other users and services (including connection service, health service, finance services, etc). The digital infrastructure platform 115 enables owners of infrastructures to better manage and control those infrastructures. The virtual reality service platform 120 provides a variety of virtual reality services to end users, digital platforms and/or other service entities, such as XaaS services, in communication with the C/M 105.

When establishing the digital platforms, the C/M 105 may allocate network resources to support the expected requirements of each digital platform. For instance, a digital platform may have specified or expected storage and/or processing requirements. In this case the system C/M 105 may allocate cache/storage resources and/or processing resources to support the functions of that digital platform.

When coordinating interaction among digital platforms, the system C/M 105 is operative to interact with each of the digital platforms to coordinate the interaction as required to obtain relevant results and/or information from source digital platforms to provide to recipient digital platforms, For example, when a tele-presence (virtual reality) is created, the digital tele-presence platform generating and maintaining the environment may request via the system C/M 105 digital user information from the digital user platform 110 and environment information from the digital infrastructure platform 115. The digital tele-presence platform may then inform the environment and interactions it supports with the received digital user information and environment information.

When interfacing, the system C/M 105 is responsive to handle requests for information and to provide information between the digital platforms and other service entities, such as XaaS service modules, available to the system C/M 105. For example, digital user information may be twinned to an external user data store available through an XaaS service module in communication with the system C/M 105. The digital user platform 110 may request updated user information from the system C/M 105, and the system C/M 105 may request and receive the user information from the XaaS service module to provide to the digital user platform 110 responsive to the request for updated user information.

As part of a communication system 100, the system C/M 105 manages access to information stored, processed, and/or generated by the digital platforms. Furthermore, the system C/M 105 handles requests for information from the digital platforms and provides intra-platform coordination, control, and access.

The digital user platform 110 is operative to store and update sets of digital user information. The digital infrastructure platform 115 is operative to support one or more simulation environments. The virtual reality service platform 120 is operative to provide a digital service, i.e. digital world, and to interact with the digital user component 110 and the digital infrastructure platform 115 to update the digital service and adapt to changing conditions within the digital service, either by evolution of the digital service, actions of digital users, or input from an outside service or user.

Additional platforms may be provided under control of the system C/M 105, such as additional virtual reality service platforms 120 providing varied digital service environments, or additional other service platforms 125 to extend the functionality of the digital communication system 100.

In some embodiments, the digital user platform 110 may be operative to provide a set of one or more digital user profiles corresponding to an external user profile maintained outside the digital communication system 100. In some aspects, at least one of the digital user profiles may be twinned to the external user profile. In these embodiments, the system C/M 105 may be operative to provide updates to a twinned digital user profile to reflect a current status of the external user profile. In some embodiments, the digital user platform 110 may provide a plurality of sets of one or more user profiles, each set corresponding to a user. In some aspects, at least some of the users correspond to an external user profile. In some aspects, at least some of the users correspond to digital users generated, maintained, and/or updated by the digital communication system 100.

The virtual user platform 110 allows other platforms and services to interact with virtual user profiles without affecting or changing corresponding external user profiles. The use of multiple virtual user profiles corresponding to a same user allows for evaluation of the effect of changes to a user profile on an infrastructure platform or service platform that utilises that user profile. In some aspects, the digital user platform 110 may be operative to maintain for each user a separate digital user profile for each digital infrastructure platform 115 or digital service 120 that utilises a digital user profile corresponding to that user. In some aspects, the digital user platform no may be operative to maintain at least one digital user profile that may be updated or affected by a plurality of different digital user platforms 115 and/or virtual reality service platforms 120.

In some embodiments, the digital infrastructure platform 115 may be operative to support one or more digital infrastructure environments. In some aspects, at least one of the digital infrastructure environments may be twinned to an external infrastructure environment maintained outside of the digital communication system 100. An example of an external infrastructure environment may include, for instance, a communication network, a manufacturing process, a traffic environment, an agricultural process, or an energy generation system. In some aspects, a digital infrastructure environment may be a representation or a simulation of an external infrastructure environment. In some aspects, a digital infrastructure environment may be a representation or a simulation of a model of an external infrastructure environment. In some embodiments, the digital infrastructure platform 115 may maintain at least one twinned digital infrastructure environment that is structured to reflect a specific corresponding external infrastructure environment. The twinned digital infrastructure may be updated to reflect a current status of the corresponding external infrastructure environment based upon state information captured form the corresponding external infrastructure environment.

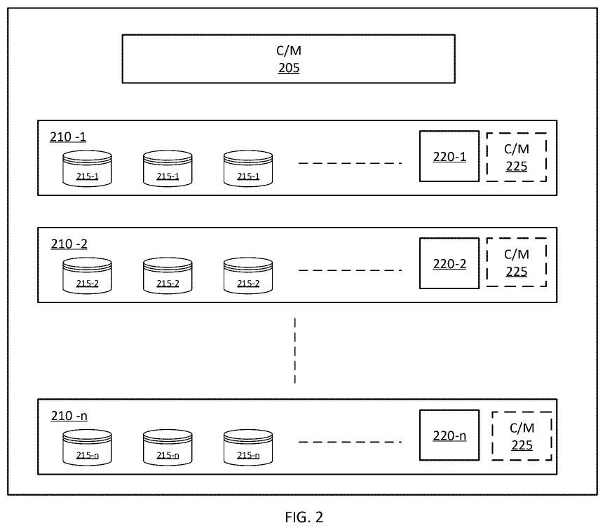

FIG. 2 is an illustrative embodiment of a simplified architecture schematic of a digital user platform 110. The digital user platform 110 includes a digital user C/M 205 and a plurality of digital user profiles 210. Each of the digital user profiles 210 corresponding to a service supported by the digital user platform 110. As indicated above, platform service messages may be used to establish platform services and/or may stipulate resourcing at the service level within a platform (e.g. allocated storage capacity, computing capacity, connectivity capability, etc.). In the context of a digital user platform 110, for instance, the platform service messages may be used to stipulate resourcing for the digital user profiles 210, or to amend resourcing of existing or pre-defined user profiles 210.

The digital user C/M 205 manages access to information stored, processed, and/or generated by the digital user platform 110 and includes network functions to establish, maintain and manage the digital user platform 110 and act as an interface with the system C/M 105 as well as other platforms within the communication system 100 such as the digital infrastructure platform 115 and virtual reality service platform 120. The digital user C/M 205 is operative to receive user information from sources external to the digital user platform 110 and to update the digital user profiles 120. The digital user C/M 205 is further operative to provide user information from the user profiles 120 responsive to external requests for user information. The digital user C/M 205 is further operative to update the digital user profiles 120 based on instructions from external sources. In some aspects, the instructions may include rules for updating specific user profiles based on changes to related user profiles. The digital user C/M 205 includes network functions operative to create, update, and extinguish digital user profiles 210 as may be required.

The user profiles 210 may each correspond to a user, i.e. a physical user or a digital user, and may include a variety of information. In some aspects, for each user a set of user profiles 210 may be maintained by the digital user platform 110 to isolate information in each user profile 210 which may vary depending upon interaction with digital infrastructure environments or digital services that interact with each user profile 210 from the set of user profiles 210 for that user. In some aspects, for each user a single user profile 210 is maintained by the digital user platform 110, with separate data stores under that user profile 210 for each digital infrastructure environment or digital service that interacts with that user profile 210.

In some embodiments, each digital user profile 210 includes a user profile C/M 225 operative to provide control and management functions for that digital user profile 210. In some embodiments, the digital user C/M 205 provides control and management functions for all of the digital user profiles 210. In either case, operation of the C/M (user profile C/M 225 or digital user C/M 205) may be configured by an external physical user or trusted entity based on a policy that may govern a variety of types of actions.

In embodiments, the user profile C/Ms 225 may be pre-configured as part of the configuration of the digital user platform 110. In embodiments, the user profile C/Ms 225 may each be configured by a corresponding user, user device, and/or trusted entity. Such configuration may include, for instance, a user profile policy to inform operation of that user profile C/Ms 225. The user profile policy may be common across multiple user profiles 210, or may be unique for one or more multiple user profiles 210. In some aspects, a set of user profiles 210 corresponding to a same user may share a common user profile policy. In some aspects, at least one user profile 210 corresponding to each user of a plurality of users may share a common user profile policy.

Each digital user profile 210 includes at least one data store 215 as well as user identifying information 220. The user identifying information 220 may include, for instance, a user ID, network address, traffic anchor, UE anchor, etc. In some embodiments, the digital user profile 210 may include a separate data store 215 for each category of user information. In some embodiments, the digital user profile 210 may include a common data store 215 for multiple, or all, categories of user information. By way of example, the data store 215 may include a plurality of different personal information types including some or all of: personal information (identifier, key, policies, etc.), digital UE information (location, anchor, data usage, etc.), health information (identifier, records, results, etc.), financial information (identifier, financial institution credentials, tracked financial information, etc.), car information (identifier, location, maintenance history, status, etc.), property information (identifier, location, maintenance tracking, etc.).

The digital user profiles 210 may be configured to perform a variety of functions, including for instance: for interactions with third party entities, assure secured interactions with those entities; for communication using mobile networks, perform UE location tracking and prediction, incoming traffic analysis functions, act as a traffic data anchor, etc; for health management, perform emergency status detection, trigger interaction with hospitals, etc.; for property management, trigger maintenance tasks, emergency status notification, etc.; for financial management, interact with authorized financial institutions under strict security protocols; etc.

The at least one data store 215 may update on different cadences, based on an information type. For instance, relatively static information (personal information, policies, financial information, health information, home information, etc.) may be updated on a slow cadence (daily, monthly, quarterly, etc.). On the other hand, relatively dynamic information (UE status, Car status, Real-time process information, etc.) may be updated on a relatively faster cadence (second, minute, hour, day, etc.). In some aspects, one or more of the information types are updated based on a push of updated information received from the system C/M 105.

In some embodiments, a digital user profile 210 may include a virtual anchor point that is associated with a data storage cache. The cache may store an anchor point policy that guides the operation of the virtual anchor point. In some embodiments, the anchor point policy may be defined or set by a physical user that is associate with, or corresponds to, the digital user profile 210. The virtual anchor point operative to receive incoming calls or messages and take one or more actions on the received incoming calls or messages. For instance, the virtual anchor point may cache the incoming calls or messages, block the calls or messages, and/or forward the calls or messages to another digital user profile 210 or to a physical user associated with that digital user profile 210. In some embodiments, the virtual anchor point may be operative to initiate calls to third parties (other digital user profiles 210 or physical users), based on a configuration of the digital user profile 210 for that virtual anchor point.

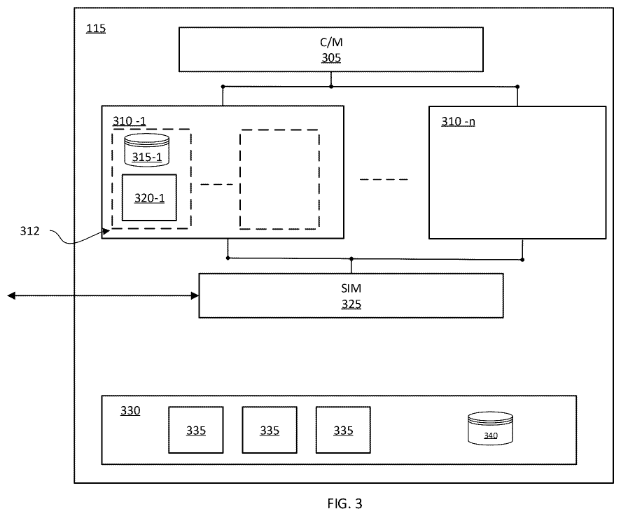

FIG. 3 is an illustrative embodiment of a simplified architecture schematic of a digital infrastructure platform 115. The digital infrastructure platform 115 includes a digital infrastructure platform C/M 305 and one or more digital infrastructure platform instances 310. Each digital infrastructure platform instance 310 corresponding to a separate digital infrastructure established and maintained by the digital infrastructure platform 115. The digital infrastructure platform instances 310 each include a digital replica of a physical infrastructure to be evaluated using the digital infrastructure platform 115.

In some embodiments, each digital infrastructure platform instance 310 includes an infrastructure instance C/M 320 operative to provide control and management functions for that digital infrastructure platform instance 310. In some embodiments, the digital infrastructure platform C/M 305 provides control and management functions for all of the digital infrastructure platform instances 310. In either case, operation of the C/M (infrastructure instance C/M 320 or digital infrastructure platform C/M 305) may be configured by an external physical user or trusted entity based on a policy that may govern a variety of types of actions.

In some embodiments, some or all of the digital infrastructure platform instances 310 may represent a different type of infrastructure (e.g. a digital mobile network, a digital road/traffic, a digital city, a digital industrial process, a digital manufactory, a digital farm, a digital power transmission grid, etc.). In some embodiments, each digital infrastructure platform instance 310 represents a different type of infrastructure, and that infrastructure may be replicated within that digital infrastructure platform instance 310. This may be useful, for instance, where a plurality of similar type infrastructures are being evaluated or “twinned”, such as for different infrastructure owners, different theoretical models, different scales of infrastructure, etc.

In some embodiments, where there are a plurality of different infrastructures replicated within a same digital infrastructure platform instance 310, there may be a separate infrastructure instance C/M 320 for each of the multiple infrastructures. In these embodiments, each of the infrastructure instance C/Ms 320 may be separately configured to control acquisition of infrastructure information from the twinned physical entity and/or adjust parameters for that replicated infrastructure. By way of example, where each replicated infrastructure corresponds to a different real world infrastructure, the corresponding infrastructure instance C/M 320 may be configured to only access information related to that real world infrastructure.

The digital infrastructure platform instances 310 may each include one or more data plane functions, each corresponding to one of the replicated infrastructures within the digital infrastructure platform instance 310. The data plane functions each store a configuration of the infrastructure being replicated (i.e. infrastructure information), and may store a usage status of the infrastructure. The usage status may, in certain embodiments be acquired from a service, available to the data plane functions, which is responsible for data collection, de-privatization, analysis and delivery (e.g. such as a DAM service).

The digital infrastructure platform 115 includes a simulation/test environment platform 325 that may be connected to each of the digital infrastructure platform instances 310 to carry out simulation or evaluation of an instance 310. The digital infrastructure platform 115 may also include a simulation environment interface 350 that provides connectivity to external XaaS resources that may support the simulation/test environment platform 325.

The digital infrastructure platform 115 may further include a simulation/test tool library 330 that may include one or more tools 335, e.g. simulators, that may be called upon by the simulation/test environment platform 325. The simulation/test tool library 330 may further include a library data store 340 for storing data and/or information relevant to the tools 335 and which may also be called upon by the simulation/test environment platform 325. The tools 335 may include validated simulators (i.e. algorithms) which may be contributed by infrastructure owners, third party providers, etc. For example, local outlier mining algorithm (LOMA) techniques may be deployed and developed for one infrastructure instance. The same technique may be applied to another instance. In the application, parameter specifics for the relevant infrastructure may be supplied by the corresponding digital infrastructure platform instance 310.

For example, in some embodiments the tools 335 may include, for instance, a network simulator, a traffic/road simulator, a manufactory simulator, a farm simulator, a process simulator, a power generation simulator, a power transmission simulator, etc. In these embodiments a digital representation of a network, such as a mobile network, may be simulated in the simulation/test environment platform 325 based on a digital infrastructure platform instance 310 that stipulates specifics of a physical network, or a theoretical network to be modeled. Generic processes or interacting components represented by one or more of the tools 335 may be accessed by the simulation/test environment platform 325 from the simulation/test tool library 330. In this example, for instance, the network simulator and traffic/road simulator tools 335 may be accessed to support simulation of the physical network or theoretical network where the simulation includes network traffic simulation and UE movement along a city road at different times of day.

The digital infrastructure platform C/M 305 is operative to determine the configuration of the simulation/test environment platform 325, maintain the simulation/test tool library 330, and to configure the simulation environment interface 350 with connected XaaS data planes.

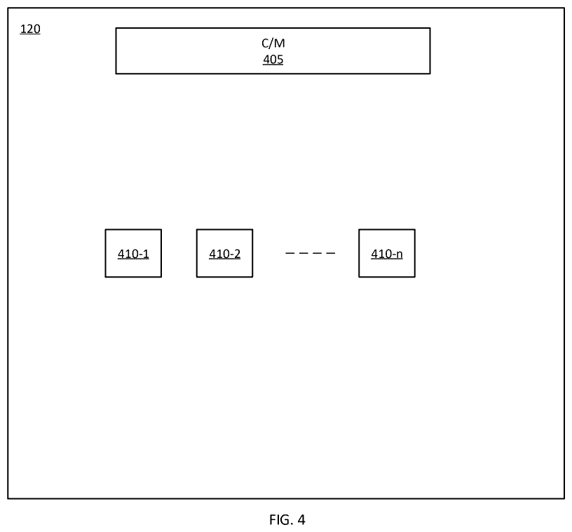

FIG. 4 is an illustrative embodiment of a simplified architecture schematic of a virtual reality service platform 120. The virtual reality service platform 120 includes a virtual reality service platform C/M 405 and one or more “alive” digital service slices (i.e. “virtual reality service slices”) 410. The virtual reality service slices 410 may require information from other platforms, including the digital user platform 110 and/or the digital infrastructure platform 115. In these embodiments, the virtual reality service platform C/M 405 may be operative to communicate with the other platforms outside of the virtual reality service platform 120, including the digital user platform 110, the digital infrastructure platform 115, and/or the system control manager C/M on behalf of a virtual reality service slice 410 that required information from that platform. For instance, the virtual reality service platform C/M 405 may be operative to obtain user identifying information from at least one digital user profile to provide to the one or more virtual reality service slices. In some aspects, the virtual reality service platform C/M 405 may be operative to obtain infrastructure information from at least one digital infrastructure instance of a digital infrastructure platform to provide to the one or more virtual reality service slices. The obtained information may be used by a virtual reality service slices to inform aspect of a virtual reality supported by that virtual reality service slice including user makeup, infrastructure makeup, user actions, responses of the virtual reality to user actions, etc.

The virtual reality service platform C/M 405 is responsible for lifecycle management of each of virtual reality service slice. This may include, for instance: development, deployment and operation of each virtual reality service slice; updating each virtual reality service slice; and, interacting with other platforms to integrate some or all of lifecycle management. The life cycle management may include obtaining digital user platform information (after authentication by the digital user C/M 205), digital infrastructure platform information (after authentication by the digital platform C/M 305), and/or adapting to the real-time behaviour of physical users/infrastructure based on updated information.

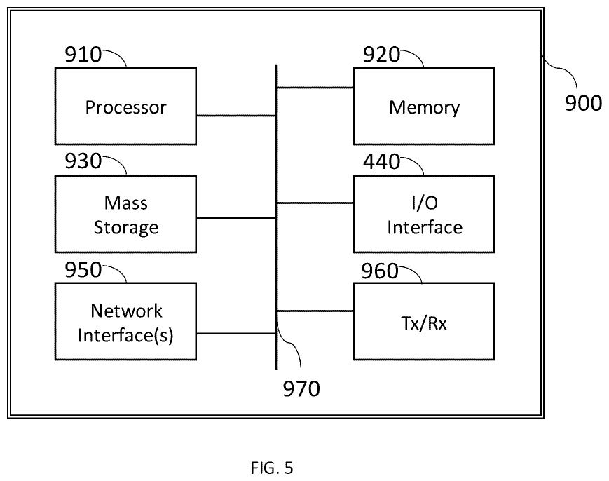

FIG. 5 is a schematic diagram of a computing device 900 that may perform any or all of operations of the methods and features explicitly or implicitly described herein, according to different embodiments of the present disclosure. For example, a computer equipped with network function may be configured as the computing device 900. One, two or more such computing devices may be coupled together in order to provide embodiments of the present disclosure. Multiple physically separate devices (e.g. in the same or separate datacenters) may be coupled together in order to provide one, two or more of such computing devices. When a device provides an infrastructure module, that device may consist primarily of an associated resource. For example, a computing module may consist primarily of computer processors, while a storage module may consist primarily of computer memory.

As shown, the device 900 may include a processor 910, such as a Central Processing Unit (CPU) or specialized processors such as a Graphics Processing Unit (GPU) or other such processor unit, memory 920, non-transitory mass storage 930, input-output interface 940, network interface 950, and a transceiver 960, all of which are communicatively coupled via bi-directional bus 970. According to certain embodiments, any or all of the depicted elements may be utilized, or only a subset of the elements. Further, device 900 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 920 may include any type of non-transitory memory such as static random access memory (SRAM), dynamic random access memory (DRAM), synchronous DRAM (SDRAM), read-only memory (ROM), any combination of such, or the like. The mass storage element 1130 may include any type of non-transitory storage device, such as a solid state drive, hard disk drive, a magnetic disk drive, an optical disk drive, USB drive, or any computer program product configured to store information and machine executable program code. According to certain embodiments, the memory 920 or mass storage 930 may have recorded thereon statements and instructions executable by the processor 910 for performing any of the aforementioned method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the disclosure have been described herein for purposes of illustration, various modifications may be made without departing from the scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the disclosure to provide a computer program product or program element, or a program storage or memory device such as a magnetic or optical wire, tape or disc, or the like, for storing signals readable by a machine, for controlling the operation of a computer according to the method of the disclosure and/or to structure some or all of its components in accordance with the system of the disclosure.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include a number of instructions that enable a computer device to execute operations for configuring or programming a virtual logic apparatus in accordance with embodiments of the present disclosure.

Although the present disclosure and invention(s) associated therewith have been described with reference to specific features and embodiments, it is evident that various modifications and combinations can be made thereto without departing from such invention(s). The specification and drawings are, accordingly, to be regarded simply as an illustration of embodiments of the disclosure, for example as defined by the appended claims, and are contemplated to cover any and all modifications, variations, combinations or equivalents that fall within the scope of the present disclosure and its invention(s).

What is claimed is:

1. A communication system comprising:
a system control manager (system C/M);
a digital user platform configured to support one or more digital user profiles;
a digital infrastructure platform configured to support at least one digital infrastructure platform instance; and
a virtual reality service platform configured to support at least one virtual reality service slice, and
wherein the system C/M is configured to establish and coordinate interaction between the digital user platform, the digital infrastructure platform and the virtual reality service platform.

2. The communication system of claim 1, wherein the system C/M is further configured to interface with a service entity outside of the communication system, and to facilitate information exchange between anything-as-a-service (XaaS) entities and the digital user platform, the digital infrastructure platform and the virtual reality service platform.

3. The communication system of claim 1, further comprising a digital user C/M configured to manage access to information stored, processed, or generated by the digital user platform.

4. The communication system of claim 1, further comprising a digital infrastructure platform C/M configured to provide control and management functions for the at least one digital infrastructure platform instance supported by the digital infrastructure platform.

5. The communication system of claim 1, further comprising a virtual reality service platform C/M configured to provide lifecycle management for the at least one virtual reality service slice.

6. The communication system of claim 1, wherein the one or more digital user profiles each comprise a separate user profile C/M configured to provide control and management functions for the respective digital user profile.

7. The communication system of claim 1, wherein at least one digital user profile of the one or more digital user profiles is twinned to replicate user information from a physical user profile.

8. The communication system claim 1, wherein at least one digital user profile of the one or more digital user profiles includes a information type selected from the following: personal information of a physical user, digital UE information of a physical user, health information of a physical user, financial information of a physical user, car information of a physical user, or property information of a physical user.

9. The communication system of claim 1, wherein at least one digital user profile of the one or more digital user profiles further comprises a virtual anchor point configured to receive incoming calls or messages.

10. The communication system of claim 1, wherein at least one digital user profile of the one or more digital user profiles further comprises a virtual anchor point configured to initiate calls to third parties.

11. The communication system of claim 1, wherein the system C/M is further configured to access information to at least one real world infrastructure to configure or update at least one of the digital user platform, the digital infrastructure platform or the virtual reality service platform.

12. The communication system of claim 1, wherein the virtual reality service platform is configured to generate a virtual reality based on information received from the digital user platform or the digital infrastructure platform.

13. A digital user platform comprising:
a digital user control manager (C/M); and
one or more digital user profiles;
wherein the digital user C/M is configured to manage access to information stored, processed, or generated by each digital user profile of the one or more digital user profiles.

14. The digital user platform of claim 13, wherein the digital user profiles each comprise a separate user profile C/M configured to provide control and management functions for the respective digital user profile.

15. The digital user platform of claim 13, wherein at least one digital user profile of the one or more digital user profiles is twinned to replicate user information from a physical user profile.

16. The digital user platform of claim 13, further comprising a virtual anchor point associated with at least one digital user profile of the one or more digital user profiles.

17. The digital user platform of claim 13, wherein at least one digital user profile of the one or more digital user profiles includes a information type selected from the following: personal information of a physical user, digital UE information of a physical user, health information of a physical user, financial information of a physical user, car information of a physical user, or property information of a physical user.

18. A digital infrastructure platform comprising:
one or more digital infrastructure platform instances;
a simulation/test environment platform, configured to carry out simulation or evaluation of the one or more digital infrastructure platform instances; and
a simulation/test tool library, including at least one simulation tool callable by the simulation/test environment platform.

19. The digital infrastructure platform of claim 18, wherein the one or more digital infrastructure platform instances comprise a representation of a structure selected from: a digital mobile network, a digital road/traffic, a digital city, a digital industrial process, a digital manufactory, a digital farm, or a digital power transmission grid.

20. The digital infrastructure platform of claim 18, wherein at least one digital infrastructure platform instance of the one or more digital infrastructure platform instances comprises a plurality of different infrastructures replicated within a same digital infrastructure platform instance.
